(19) United States
(12) Patent Application Publication
(10) Pub. No.: US 2026/0097780 A1
(43) Pub. Date: Apr. 9, 2026

(54) VEHICLE CONTROL DEVICE AND STORAGE MEDIUM

(71) Applicant: TOYOTA JIDOSHA KABUSHIKI KAISHA, Toyota-shi (JP)

(72) Inventor: Shinsaku YOSHINAKA, Nagakute-shi (JP)

(73) Assignee: TOYOTA JIDOSHA KABUSHIKI KAISHA, Toyota-shi (JP)

(21) Appl. No.: 19/336,925

(22) Filed: Sep. 23, 2025

(30) Foreign Application Priority Data
Oct. 7, 2024 (JP) 2024-175965

(51) Int. Cl. B60W 50/14; G06T 7/70; G06V 20/56; G06V 20/58

(52) U.S. Cl. CPC B60W 50/14; G06T 7/70; G06V 20/582; G06V 20/588; B60W 2420/403; B60W 2552/53; B60W 2555/60; G06T 2207/30256

(57) ABSTRACT

A vehicle control device includes a controller configured to execute driving assistance control of a vehicle, in which the controller is configured to analyze imaging data obtained by imaging an environment around the vehicle, recognize a road present in a direction in which the vehicle travels in the environment, recognize a predetermined sign indicating no entry on the road, recognize a no-entry road on the road in which the predetermined sign is present, cause, when determination is made that the vehicle enters the no-entry road, an output unit to output a predetermined warning, and determine, when the road in which the predetermined sign is present is branched into a first road and a second road, that any one of the first road and the second road is the no-entry road based on a positional relationship between the sign that is predetermined, the first road, and the second road.

### CROSS-REFERENCE TO RELATED APPLICATION

This application claims priority to Japanese Patent Application No. 2024-175965 filed on October 7, 2024. The disclosure of the above-identified application, including the specification, drawings, and claims, is incorporated by reference herein in its entirety.

### BACKGROUND

### 1. Technical Field

The present disclosure relates to a vehicle control device and a storage medium for executing driving assistance.

### 2. Description of Related Art

For example, Japanese Unexamined Patent Application Publication No. 2016-224714 (JP 2016-224714 A) discloses an entry determination device that can determine whether a vehicle has entered a no-entry road. The entry determination device disclosed in JP 2016-224714 A recognizes predetermined signs indicating no entry on both sides of a road in a traveling direction, based on image data obtained by capturing an image of the surroundings of the vehicle. The entry determination device is configured to determine that the vehicle has entered the no-entry road when the vehicle has passed between the predetermined signs.

### SUMMARY

According to the technique disclosed in JP 2016-224714 A, in a road in which the predetermined sign indicating no entry is present on only one side of the road, there is a possibility that the vehicle cannot determine the no-entry road.

An object of the present disclosure is to provide a vehicle control device and a storage medium that improve an accuracy of determining a no-entry road.

According to an aspect of the present disclosure, a vehicle control device includes a controller configured to execute driving assistance control of a vehicle, in which the controller is configured to analyze image data obtained by capturing an image of surroundings of the vehicle, recognize a road present in a direction in which the vehicle travels in the surroundings, recognize a predetermined sign indicating no entry on the road, recognize a no-entry road on the road in which the predetermined sign is present, cause, when determination is made that the vehicle enters the no-entry road, an output unit to output a predetermined warning, and determine, when the road in which the predetermined sign is present is branched into a first road and a second road, that any one of the first road and the second road is the no-entry road, based on a positional relationship between the predetermined sign, the first road, and the second road.

According to the present disclosure, it is possible to improve the accuracy of determining the no-entry road.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a configuration of a vehicle 1 according to an embodiment of the present disclosure;

FIG. 2 is a diagram showing an example of imaging data obtained by imaging an environment around the vehicle;

FIG. 3 is a diagram showing another example of the imaging data; and

FIG. 4 is a flowchart showing a flow of a process of a vehicle control method executed in a vehicle control device.

### DETAILED DESCRIPTION OF EMBODIMENTS

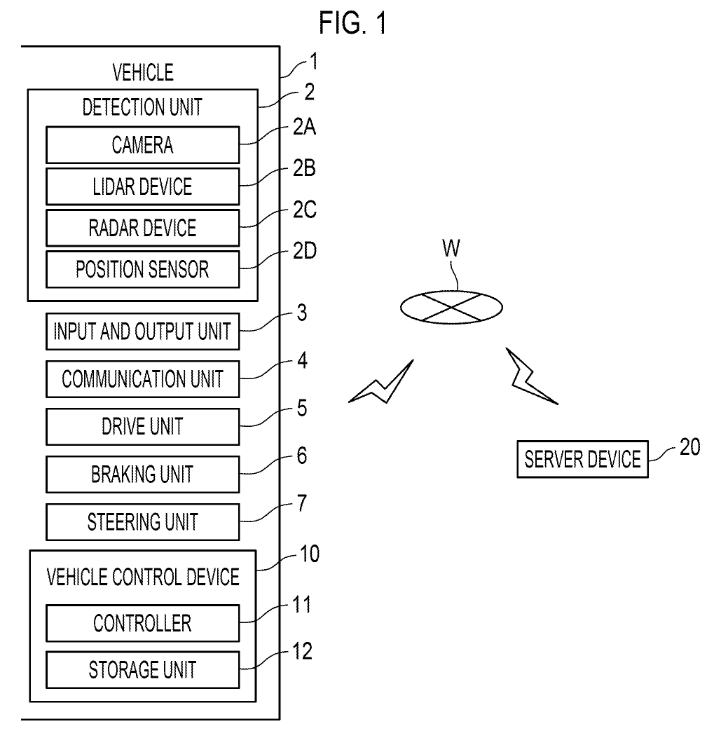

As shown in FIG. 1, a vehicle 1 is configured to execute driving assistance. The vehicle 1 is constituted by a detection unit 2 and a vehicle control device 10 to execute the driving assistance, such as advanced driver-assistance systems (ADAS). The detection unit 2 detects an environment around the vehicle 1. The detection unit 2 is constituted by a plurality of devices according to the use. A detection value detected by the detection unit 2 is used for the driving assistance, a navigation device, or the like.

The detection unit 2 includes a camera 2A that images the environment around the vehicle 1. The camera 2A captures an image around the vehicle 1 and outputs imaging data. In the present embodiment, the camera 2A images a range that is predetermined in front of the vehicle 1. The imaging data of the camera 2A is used, for example, for the driving assistance of the vehicle 1 or a drive recorder. An imaging range and an imaging direction of the camera 2A may be different depending on the vehicle 1.

The detection unit 2 includes a lidar device 2B that detects three-dimensional data around the vehicle 1. The lidar device 2B irradiates a detection region with a laser light in front of the vehicle 1 or around the vehicle 1 and measures the reflected light from an object at a constant cycle. The lidar device 2B is configured to adjust the detection region. The lidar device 2B scans the detection region with the laser light and acquires measurement data. The lidar device 2B is configured to generate three-dimensional point cloud data around the vehicle 1 based on the measurement data.

A measured value of the lidar device 2B is used to detect traffic participants such as other vehicles, pedestrians, bicycles, and motorcycles that are present around the vehicle 1 or objects present around the vehicle 1. The lidar device 2B detects a road structure present in a road environment.

The detection unit 2 includes, for example, a radar device 2C that detects the object present around the vehicle 1 by scanning radar waves. The radar device 2C is configured to complementarily detect the object with the lidar device 2B. The radar device 2C detects a relative distance to the object by irradiating the detection region with a millimeter wave radar wave and receiving a reflection wave reflected by the object. The radar device 2C is configured to adjust the detection region.

A measured value of the radar device 2C is used to detect traffic participants such as other vehicles, pedestrians, bicycles, and motorcycles that are present around the vehicle 1 or objects present around the vehicle 1. The radar device 2C detects the road structure present in the road environment. An object recognition unit is constituted by the lidar device 2B and/or the radar device 2C.

The detection unit 2 includes a position sensor 2D that detects a current position of the vehicle 1. The position sensor 2D is, for example, a global positioning system (GPS) sensor or a global navigation satellite system (GNSS) sensor. The position sensor 2D may complement the position of the vehicle 1 with each other by an autonomous sensor (not shown) such as a gyro sensor or an acceleration sensor used for autonomous navigation.

The vehicle 1 includes an input and output unit 3 that can display information while receiving an operation of a user. The input and output unit 3 is, for example, constituted by a touch panel that can display a display image and receive a touch operation. The input and output unit 3 may be individually constituted by an input unit and a display unit. The input unit receives an input operation, such as a physical switch, and the display unit can display information of a display device, such as a liquid crystal display (LCD) or an organic electro luminescence (EL) display.

The input and output unit 3 may include a speaker that outputs sound information, an indicator that outputs light emission information, a vibrator that outputs vibration information, and the like. The input and output unit 3 has a function as an output unit that outputs information in at least one aspect of characters, images, sounds, light emission, vibration, and the like.

The vehicle 1 includes a communication unit 4 that can be communicatively connected to a network W. The communication unit 4 is a communication interface configured to perform wireless communication. The communication unit 4 communicates with various communication targets via the network W, for example, by being communicatively connected to a wireless base station present around the vehicle 1. The vehicle 1 communicates with a server device 20 communicatively connected to the network W, for example, and acquires map data including the current position of the vehicle 1.

The vehicle 1 includes a drive unit 5 that generates traveling power. The drive unit 5 is constituted by, for example, an internal combustion engine using fuel. The drive unit 5 is constituted by an electric motor when the vehicle 1 is an electrified vehicle. The drive unit 5 may be constituted by combining the internal combustion engine and the electric motor when the vehicle 1 is a hybrid electric vehicle. The drive unit 5 is controlled by the vehicle control device 10 when the driving assistance is executed, and the speed is adjusted.

The vehicle 1 includes a braking unit 6 for decelerating a vehicle speed and controlling the vehicle to be in a stop state. The braking unit 6 is constituted by, for example, a brake device that generates a braking force. The braking unit 6 may be integrated with the drive unit 5 when the vehicle 1 is an electrified vehicle. The braking unit 6 is controlled by the vehicle control device 10 when the driving assistance is executed.

The vehicle 1 includes a steering unit 7 for operating a traveling direction. The steering unit 7 is constituted by a power steering device or the like that gives a steering angle to a steering wheel in response to a steering operation. The steering unit 7 may be integrated with the drive unit 5 that variably controls the right and left driving forces of the drive wheels when the vehicle 1 is an electrified vehicle. The steering unit 7 is controlled by the vehicle control device 10 when the driving assistance is executed, and the steering angle is adjusted.

The vehicle control device 10 includes a controller 11 that executes control related to traveling of the vehicle 1. The controller 11 integrates and executes control of traveling of the vehicle 1, driving assistance, navigation, communication via the network W, and the like based on the detection value detected by the detection unit 2. The controller 11 is constituted by at least one hardware processor, such as a central processing unit (CPU). The controller 11 may be realized by hardware (circuit unit, including circuitry) such as large scale integration (LSI), application specific integrated circuit (ASIC), field-programmable gate array (FPGA), or graphics processing unit (GPU). The controller 11 may be realized by the cooperation of software and hardware.

The vehicle control device 10 includes a storage unit 12 that stores data and a program. The storage unit 12 is constituted by a non-transitory storage medium, such as a hard disk drive (HDD) or a solid state disk (SSD). The storage unit 12 stores a computer program and data necessary for controlling the vehicle 1. The program may be stored in the storage unit 12 in advance, or may be stored in an external connectable storage medium, such as a DVD or a CD-ROM, and may be installed in the storage unit 12 by mounting the storage medium on a drive device. The controller 11 controls the drive unit 5, the braking unit 6, and the steering unit 7 based on the detection value detected by the detection unit 2, and executes driving assistance control, such as an obstacle anticipation assist (OAA).

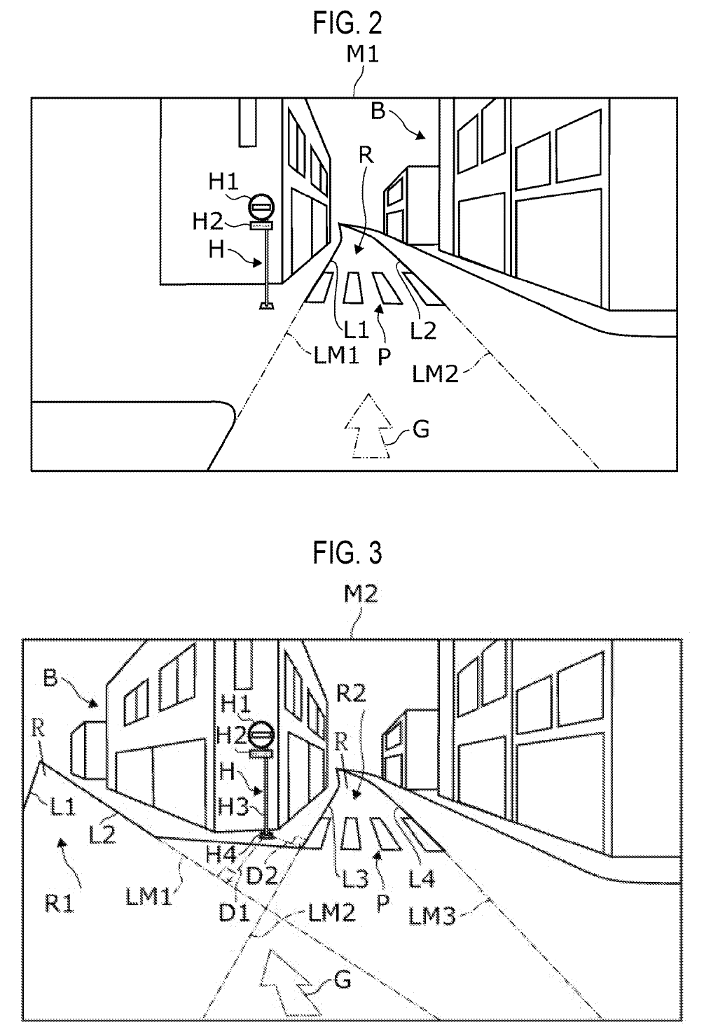

As shown in FIG. 2, the vehicle 1 is configured to execute the driving assistance control based on the recognition result of imaging data M1 obtained by imaging the environment around the vehicle 1. The controller 11 acquires the imaging data M1 imaged by the camera 2A. The controller 11 is configured to execute machine learning, such as deep learning, using imaging data obtained by imaging a road environment in which the vehicle travels as training data in advance, and to recognize the content of an information providing object present in the environment and the environment around the vehicle 1.

The controller 11 analyzes the imaging data M1 to recognize a structure such as a road R, a road structure, a road sign H, a road surface display P, a building B, or a traffic participant such as another vehicle or a pedestrian from the environment around the vehicle 1. When the controller 11 extracts the information providing object, such as the road sign H and the road surface display P, from the imaging data M1, the controller 11 recognizes the content of the provided information. The controller 11 recognizes the road R present in the environment in which the vehicle 1 travels in a direction G, for example, in the imaging data M1.

When a road boundary line Ln (n: natural number) is present on the road R, the controller 11, for example, sets the road boundary line Ln as a road boundary and recognizes the road R. The controller 11 recognizes the road surface between an adjacent pair of road boundary lines Ln as the road R. When the boundary line cannot be recognized on the road R, the controller 11 sets a virtual road boundary based on a disposition state of the structure adjacent to the road. When the road boundary line Ln is not present on the road R, the controller 11 extracts the feature portion of the structure present in the road environment, such as the color of the pavement surface, the presence or absence of the sidewalk, the presence or absence of the road structure such as the guardrail, and the positional relationship with the building B. Then, the controller 11 sets a virtual road boundary line LMm (m: natural number) on the road R.

The controller 11 executes a process of treating the set virtual road boundary line LMm as the road boundary. The controller 11 recognizes the road surface between an adjacent pair of virtual road boundary lines LMm as the road R. The controller 11 may recognize the road surface between the adjacent road boundary line Ln and the virtual road boundary line LMm as the road R. The controller 11 may collate the map data acquired from the server device 20 and the position data of the position sensor 2D to recognize the road R.

The controller 11 recognizes the road sign H present in the vicinity of the road R. The controller 11 recognizes a signboard H1 of the road sign H and analyzes the content of the information displayed on the signboard H1. The controller 11 recognizes the figure and the character displayed on the signboard H1, and recognizes the content of the information displayed on the signboard H1 based on the figure information and the character information. When the content of the information displayed on the signboard H1 is a sign that is predetermined that regulates the passage of the vehicle 1, such as vehicle no-entry, road closed, or passage in a direction other than a designated direction, the controller 11 determines whether the vehicle 1 can pass the road R.

Among the contents of the information displayed on the signboard H1, there may be information indicating a traffic regulation, such as a traffic regulation based on a vehicle category, a traffic regulation based on a vehicle weight, a traffic regulation based on a vehicle width or a vehicle height, or a traffic regulation based on a load. At this time, the controller 11 compares specification data of the vehicle 1 with the content of the traffic regulation. When the specifications of the vehicle 1 correspond to the traffic regulation, the controller 11 determines that the vehicle 1 cannot pass the road R. When the specifications of the vehicle 1 do not correspond to the traffic regulation, the controller 11 determines that the vehicle 1 can pass the road R.

When an auxiliary sign H2 present in the road sign H is recognized, the controller 11 analyzes the content of the information displayed on the auxiliary sign H2. Among the contents of the information displayed on the signboard H1, there may be a case where a traffic regulation based on a vehicle category, a traffic regulation based on a day or a time zone, and a traffic regulation such as a section or an area end point, a start point, or within a section or an area is present. At this time, the controller 11 compares the specification data of the vehicle 1, the current date and time data, the current position data, and the content of the traffic regulation. When the specifications, the date and time, and the position of the vehicle 1 correspond to the traffic regulation, the controller 11 determines that the vehicle 1 cannot pass the road R. When the specifications, the date and time, and the position of the vehicle 1 do not correspond to the traffic regulation, the controller 11 determines that the vehicle 1 can pass the road R.

When the controller 11 recognizes the sign that is predetermined indicating no entry on the road R, the controller 11 recognizes that the road R on which the sign that is predetermined is present is the no-entry road. The controller 11 executes driving assistance control of outputting a warning that is predetermined to the input and output unit 3 when the vehicle 1 is determined to enter the no-entry road. The determination is made based on, for example, the position data acquired from the position sensor 2D, the imaging data acquired from the camera 2A, the map data acquired from the server device 20, or the like. The controller 11 may execute the driving assistance control for outputting the warning that is predetermined to the input and output unit 3 at a distance that is predetermined or a time that is predetermined before the vehicle 1 enters the no-entry road when the vehicle 1 is predicted to enter the no-entry road.

The controller 11 may execute the driving assistance control for restraining the vehicle 1 from entering the no-entry road at a distance that is predetermined or a time that is predetermined before the vehicle 1 enters the no-entry road when the vehicle 1 is predicted to enter the no-entry road. The driving assistance control is performed by the controller 11 controlling the drive unit 5, the braking unit 6, and the steering unit 7. The controller 11 generates at least one of character information, image information, sound information, light emission information, vibration information, or the like that is a warning for entering the no-entry road, and outputs the at least one information from the input and output unit 3.

As shown in FIG. 3, the road R may be branched into a first road R1 and a second road R2. In the example shown in the drawing, the road R is branched into the first road R1 and the second road R2, and an example of the road environment in which one sign that is predetermined is present at a branch portion of the road R is shown. When the road R having the sign that is predetermined is branched into the first road R1 and the second road R2, the controller 11 determines that any one of the first road R1 and the second road R2 is the no-entry road. The determination is based on a positional relationship between the sign that is predetermined, the first road R1, and the second road R2.

The controller 11 recognizes the first road R1 and the second road R2 based on imaging data M2. The controller 11 recognizes a first road boundary and a second road boundary included in a road boundary or a virtual road boundary on the road R that is branched into the first road R1 and the second road R2. The controller 11 recognizes the first road R1 and the second road R2 based on, for example, the road boundary line Ln. The controller 11 recognizes the road surface between the adjacent road boundary lines Ln as the first road R1 or the second road R2.

When the road boundary line Ln is not present, the controller 11 sets the virtual road boundary line LMm and recognizes that the road surface between the adjacent virtual road boundary lines LMm is the first road R1 or the second road R2. The controller 11 recognizes the road surface between the adjacent road boundary line Ln and the virtual road boundary line LMm as the road R. The controller 11 recognizes the first road boundary of the first road R1 based on the road boundary line Ln and/or the virtual road boundary line LMm. The controller 11 recognizes the second road boundary of the second road R2 based on the road boundary line Ln and/or the virtual road boundary line LMm.

The controller 11 determines whether the road sign H is the sign that is predetermined when the road sign H is present on the road R branched into the first road R1 and the second road R2. The controller 11 analyzes the content of the information indicated by the road sign H. The controller 11 determines whether the sign that is predetermined belongs to any of the first road R1 and the second road R2 when the controller 11 recognizes that the road sign H is the sign that is predetermined.

The controller 11 recognizes an installation position on the road R of the sign that is predetermined, for example. The controller 11 recognizes a pillar H3 that supports the signboard H1 of the road sign H, for example, based on the imaging data M2. The controller 11 recognizes an installation point H4 of the pillar H3 on the road surface. The installation point H4 is a base end portion of the pillar H3 on the road surface. The controller 11 may recognize the installation point H4 of the pillar H3 on the ground by using the detection value of the lidar device 2B and/or the radar device 2C. The controller 11 recognizes the installation point H4 of the sign that is predetermined of the pillar H3 on the ground as the installation position of the road sign H. When the signboard H1 is installed in the air, the controller 11 may set the vertical projection position of the signboard H1 onto the road surface as the virtual installation point.

The controller 11 recognizes the first road boundary of the first road R1 and measures a first distance between the installation position of the sign that is predetermined and the first road boundary. The controller 11 sets, for example, a length of a first perpendicular line D1 to the first road boundary adjacent to the installation position as the first distance. The controller 11 recognizes the second road boundary of the second road R2 and measures a second distance between the installation position of the sign that is predetermined and the second road boundary. The controller 11 sets, for example, a length of a second perpendicular line D2 to the second road boundary adjacent to the installation position as the second distance.

The controller 11 compares the first distance between the installation position of the sign that is predetermined and the first road boundary and the second distance between the installation position of the sign that is predetermined and the second road boundary. The controller 11 determines that the road to which the distance closer to the installation position belongs is the no-entry road based on the comparison result between the first distance and the second distance. In the example shown in the drawing, the controller 11 determines that the second distance of the second road boundary is shorter than the first distance of the first road boundary, and recognizes that the sign that is predetermined belongs to the second road R2. The controller 11 recognizes that the second road R2 to which the sign that is predetermined belongs is the no-entry road.

The controller 11 executes the driving assistance control for restraining the vehicle 1 from entering the second road R2 by controlling the input and output unit 3, the drive unit 5, the braking unit 6, and the steering unit 7, for example, and executes the driving assistance control for urging the vehicle 1 to travel on the first road R1.

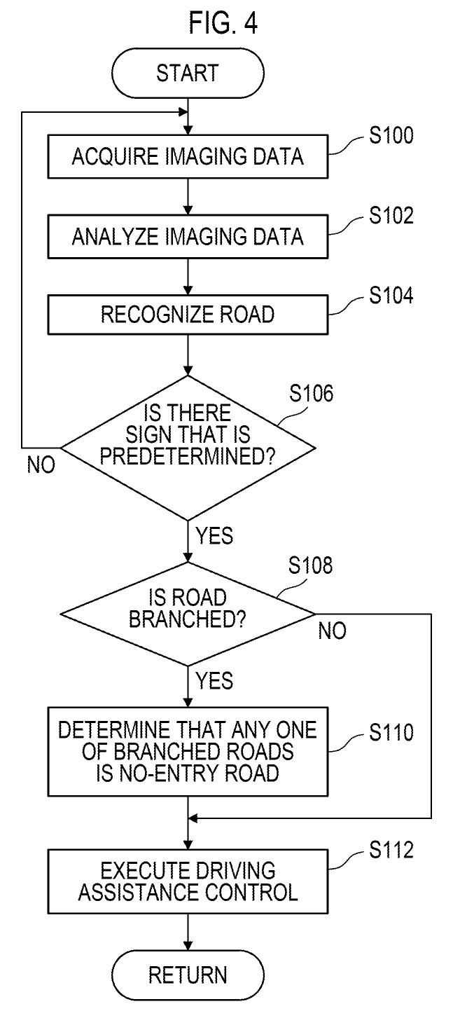

FIG. 4 shows a flow of a process of a vehicle control method executed in the vehicle control device 10. The vehicle control method is executed based on a computer program that is installed in a computer mounted on the vehicle control device 10 that executes the driving assistance control of the vehicle. The computer program causes the controller 11 of the vehicle control device 10 to execute the following process.

The controller 11 acquires imaging data obtained by imaging the environment around the vehicle 1 from the camera 2A (S100). The controller 11 analyzes the imaging data (S102). The controller 11 recognizes the road present in a direction in which the vehicle travels in the environment (S104). The controller 11 determines whether a sign that is predetermined indicating no entry is present on the road R (S106). When determination is made that the sign that is predetermined is present, the controller 11 determines whether the road R is branched (S108).

When the road R having the sign that is predetermined is branched into the first road R1 and the second road R2 (S108: Yes), the controller 11 determines that any one of the first road R1 and the second road R2 is the no-entry road (S110). The determination is based on a positional relationship between the sign that is predetermined, the first road R1, and the second road R2. When the road R on which the sign that is predetermined is present is not branched (S108: No), the controller 11 recognizes that the road R on which the sign that is predetermined is present is the no-entry road, and the process proceeds to S112. When the determination is made that the vehicle 1 has entered the no-entry road, the controller 11 executes the driving assistance control, such as causing the input and output unit 3 to output a warning that is predetermined (S112).

As described above, according to the vehicle control device 10, in the road environment in which the road R on which the sign that is predetermined indicating the no entry is present is branched, the accuracy of determining the road on which entry is prohibited can be improved. According to the vehicle control device 10, it is possible to determine whether the vehicle is on the road belonging to any one of the roads into which the sign that is predetermined is branched in the branched road environment, and to specify the no-entry road. In addition, the vehicle control device 10 can use the positional relationship between the sign that is predetermined and the first road R1 and the second road R2 in the determination process. As a result, even when the sign that is predetermined is present at the branch portion of the road R, it is possible to determine that any one of the first road R1 and the second road R2 is the no-entry road.

In the embodiment, the computer program executed in each of the configurations of the vehicle control device 10 may be provided in a form recorded on a computer-readable portable recording medium (storage medium), such as a semiconductor memory, a magnetic recording medium, or an optical recording medium. The computer program may be provided as a program product.

What is claimed is:

1. A vehicle control device comprising a controller configured to execute driving assistance control of a vehicle, wherein the controller is configured to
analyze image data obtained by capturing an image of surroundings of the vehicle,
recognize a road present in a direction in which the vehicle travels in the surroundings,
recognize a predetermined sign indicating no entry on the road,
recognize a no-entry road on the road in which the predetermined sign is present,
cause, when determination is made that the vehicle enters the no-entry road, an output unit to output a predetermined warning, and
determine, when the road in which the predetermined sign is present is branched into a first road and a second road, that any one of the first road and the second road is the no-entry road, based on a positional relationship between the predetermined sign, the first road, and the second road.

2. The vehicle control device according to claim 1, wherein the controller is configured to
recognize an installation position of the predetermined sign on the road,
recognize a first road boundary of the first road,
recognize a second road boundary of the second road, and
determine, based on a comparison result between a first distance between the installation position and the first road boundary and a second distance between the installation position and the second road boundary, a road closer to the installation position as the no-entry road.

3. The vehicle control device according to claim 2, wherein the controller is configured to
recognize an installation point of the predetermined sign with respect to a road surface of the road as the installation position,
set a length of a first perpendicular line to the first road boundary adjacent to the installation position as the first distance, and
set a length of a second perpendicular line to the second road boundary adjacent to the installation position as the second distance.

4. The vehicle control device according to claim 2, wherein the controller is configured to
set, when a boundary line is recognized on the road, the boundary line as a road boundary,
set, when the boundary line is not recognized on the road, a virtual road boundary based on a disposition state of a structure adjacent to the road, and
recognize the first road boundary and the second road boundary included in the road boundary.

5. A non-transitory storage medium storing a computer program that is installed in a computer mounted in a vehicle control device that executes driving assistance control of a vehicle, the computer program causing the computer to execute:
analyzing image data obtained by capturing an image of surroundings of the vehicle;
recognizing a road present in a direction in which the vehicle travels in the surroundings;
recognizing a predetermined sign indicating no entry on the road;
recognizing a no-entry road on the road in which the predetermined sign is present,
causing, when determination is made that the vehicle enters the no-entry road, an output unit to output a predetermined warning; and
determining, when the road in which the predetermined sign is present is branched into a first road and a second road, that any one of the first road and the second road is the no-entry road, based on a positional relationship between the predetermined sign, the first road, and the second road.
